(19) United States
(12) Patent Application Publication
(10) Pub. No.: US 2021/0199230 A1
(43) Pub. Date: Jul. 1, 2021

(54) MORTAR COLLAR

(71) Applicant: Keith Joseph Zinkovich, Terre Haute, IN (US)

(72) Inventor: Keith Joseph Zinkovich, Terre Haute, IN (US)

(21) Appl. No.: 16/730,308

(22) Filed: Dec. 30, 2019

(51) Int. Cl. F16L 55/16; E02D 37/00; E02D 29/045

(52) U.S. Cl. CPC F16L 55/16; E02D 2300/0021; E02D 29/045; E02D 37/00

(57) ABSTRACT

A mortar collar positionable to contain and protect a flowable sealant during curing thereof.

### FIELD OF THE DISCLOSURE

The present disclosure relates generally to a backstop for flowable sealant and, more particularly, to a mortar collar adapted to facilitating installation and/or repairs of storm or wastewater sewers.

### BACKGROUND/SUMMARY

Sewer systems generally consist of infrastructure that conveys sewage or surface runoff (stormwater, melt, etc.) to collection/treatment facilities. Sewer systems (or more generally, “sewers”) incorporate collection points tied to conduit arranged to convey the sewage or surface runoff. The conduit may be arranged to convey its contents under a gravity flow and the sewer system may also incorporate one or more pumping stations to facilitate the operative flow. The conduit of a sewer system may by formed by polyvinyl chloride (PVC), concrete or vitrified clay pipe (VCP), for example. The conduit system of a sewer system comprises a number of conduit segments in fluid communication with, e.g., a number of basins serving a variety of purposes. For example, catch basins can be used as a collection point for runoff in a storm sewer (such catch basins being fluidly connected, e.g., to a street gutter). Catch basins also function to retain matter that would not be able to pass easily through the remainder of the sewer system. Basins in a sewer system may also serve to connect a number of inlet conduits to an one or more outlet conduits. Such basins are accessible through manholes and are often colloquially referred to simply as “manholes.”

At connection points between elements of a sewer system, it is important to prevent exfiltration of the contents conveyed by the sewer system to the surrounding environment. It is also important to the health of a sewer system to prevent infiltration of foreign objects such as soil. To prevent these deleterious effects, conduits are sealed to basins in sewer systems.

Components of a sewer system can become compromised by the ingrowth of roots, shifting of one buried component relative to another, or for a variety of alternative reasons. When repairing a sewer system or at initial installation, conduits are sealed to other structures, e.g., basins. The basins can be made of concrete, plastic or other materials. Without regard to the material of the basin, the procedure for sealing a conduit therewith is the same. A hole is cut through the basin having a size larger than the conduit to be connected to the basin. This allows for flexibility in the positioning of the conduit relative to the basin, which is an inexact procedure subject to influence by the surrounding excavation.

In an initial installation, the components of the system, e.g., a conduit and basin are set in the earth, with the conduit extending from an exterior of the basin to an interior of the basin. Owing to the inexactness and potential irregularities of the excavation into which the components are sunk, the conduit may extend more or less than initially thought into the basin. In a repair situation, the old and perhaps failed sealant will be removed and perhaps the hole through the basin through which the conduit extends enlarged as part of the repair.

In the past, flowable sealant in the form of mortar, grout, or concrete would be packed into the gaps between the conduit and the wall of the basin in which the aperture through which the conduit is positioned resides and could possibly be forced from its sealing position before becoming cured or non-flowable. For example, if the excavation was backfilled prior to curing of the flowable sealant, then the backfill could force the flowable sealant into the basin and out of the gap between the basin wall and the conduit.

The present disclosure provides a mortar collar positionable to contain and protect a flowable sealant during curing thereof.

In an exemplification thereof, the present disclosure provides a mortar collar for protecting a flowable sealant positioned between a wall having an aperture through which a conduit is positioned, the mortar collar comprising: a conduit clamp having a wall having a height spanning a first end and a second end of the wall, the wall of the conduit clamp positionable in a clamp configuration, in the clamp configuration an interior surface of the wall of the conduit clamp having a shape corresponding to a perimeter shape of a perimeter of the conduit, such that the wall is sealable against the conduit, in the clamp configuration, and with the conduit clamp is positioned about the perimeter of the conduit, the interior surface of the wall of the conduit clamp abutting a perimeter of the conduit; and a flange extending outwardly from an exterior surface of the wall of the conduit clamp at the first end of the wall, the flange sized to cover the aperture in the wall through which the conduit is positioned when the conduit clamp is positioned about the perimeter of the conduit.

In embodiments thereof, the mortar collar defines a continuous longitudinal slit through the wall of the conduit clamp and the flange, the mortar collar openable along the slit to be positionable over the perimeter of the conduit in a direction orthogonal to a longitudinal axis of the conduit. In certain embodiments, the perimeter comprises a circumference, as the conduit is cylindrical.

In additional embodiments thereof, the wall is a basin wall and the conduit is in fluid communication with an interior of the basin, the wall defining a wall radius of curvature in a plane perpendicular to a longitudinal axis of the basin, wherein the flange defines a flange radius of curvature mating with the wall radius of curvature, whereby, with the flange positioned atop the wall, the flange abuts the wall.

In further embodiments thereof, in the clamp configuration an interior surface of the wall of the conduit clamp substantially defines a cylinder.

In yet additional embodiments thereof, the conduit clamp further comprises a band clamp positionable over the wall of the conduit clamp and tightenable thereabout to secure the conduit clamp to the conduit.

In another exemplification thereof, the present disclosure provides a method of sealing a conduit within an aperture in a wall, comprising: positioning the conduit through the aperture in the wall; affixing a mortar collar about a periphery of the conduit and covering the aperture in the wall, the affixing step performed subsequent to the step of positioning the conduit through the aperture in the wall, the affixing step positioning the mortar collar to cover the aperture; and positioning a flowable sealant between the wall and the conduit in the aperture in the wall, the mortar collar covering the sealant on a first side of the wall.

In embodiments thereof, the method further comprises cutting the wall to create the aperture prior to the step of positioning the conduit through the aperture in the wall.

In additional embodiments thereof, the mortar collar comprises: a conduit clamp having a wall having a height spanning a first end and a second end of the wall, the wall of the conduit clamp positioned in the affixing step in sealing relationship with the conduit.

In further embodiments thereof, the mortar collar defines a continuous longitudinal slit through the wall of the conduit clamp, the affixing step comprising: opening the mortar collar along the slit; and positioning the conduit through the opened slit of the mortar collar.

In yet additional embodiments thereof, the step of positioning the conduit through the opened slit of the mortar collar comprises: moving the mortar collar orthogonal to a longitudinal axis of the conduit.

In yet further embodiments thereof, the mortar collar comprises: a flange extending outwardly from an exterior surface of the wall of the conduit clamp at a first end of the wall, the flange covering the aperture in the wall and abutting the wall about the aperture as a result of the affixing step.

In further additional embodiments thereof, the mortar collar comprises: a conduit clamp having a wall having a height spanning a first end and a second end of the wall, the wall of the conduit clamp positioned in the affixing step in sealing relationship with the conduit; and a flange extending outwardly from an exterior surface of the wall of the conduit clamp at a first end of the wall, the flange covering the aperture in the wall and abutting the wall about the aperture as a result of the affixing step.

In yet further additional embodiments thereof, the mortar collar defines a continuous longitudinal slit through the wall of the conduit clamp and the flange, the affixing step comprising: opening the mortar collar along the slit; and positioning the conduit through the opened slit of the mortar collar.

In still additional embodiments thereof, the step of positioning the conduit through the opened slit of the mortar collar comprises: moving the mortar collar orthogonal to a longitudinal axis of the conduit.

In still further embodiments thereof, the wall forms a part of a basin having an interior, and wherein the step of positioning the conduit through the aperture in the wall comprises positioning an end of the conduit in fluid communication with the interior of the basin.

In additional embodiments thereof, the step of affixing a mortar collar about a periphery of the conduit and covering the aperture in the wall comprises positioning the mortar collar within the interior of the basin.

In further embodiments thereof, the step of affixing a mortar collar about a periphery of the conduit and covering the aperture in the wall comprises positioning the mortar collar exterior of the basin.

In yet additional embodiments thereof, the method further comprises: affixing a second mortar collar about the periphery of the conduit and covering the aperture in the wall, the step of affixing a second mortar collar performed subsequent to the step of positioning the conduit through the aperture in the wall, the step of affixing a second mortar collar positioning the second mortar collar to cover the aperture.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of components of a sewer system;

FIG. 2 is a detailed perspective view of a basin or “manhole” with the manhole cover removed;

FIG. 3 is a perspective view of a conduit and catch basin;

FIG. 4 is a perspective view of a manhole and cooperating conduit, with the manhole cover in place;

FIG. 5 is a detailed view of a wall of a manhole marked for cutting an aperture to accommodate a conduit positioned therethrough;

FIG. 6 illustrates removal of the piece of the manhole wall marked for cutting in FIG. 5;

FIG. 7 illustrates a conduit positioned through the aperture formed in the wall of a manhole;

FIG. 8 is a perspective view of a mortar collar in accordance with the present disclosure;

FIG. 9 is another perspective view of the mortar collar of FIG. 8, with the mortar collar opened along a generally longitudinal slit formed therein to facilitate placement of the mortar collar about a conduit;

FIG. 10 is a rear elevational view of the mortar collar of FIGS. 8 and 9;

FIG. 11 is a sectional view illustrating the mortar collar of FIGS. 8-10 positioned atop the wall of a basin;

FIG. 12 is a perspective view of the conduit and basin of FIG. 7 showing the mortar collar of FIGS. 9-10 preliminarily positioned about the conduit;

FIG. 13 is a perspective view similar to FIG. 12, with the mortar collar moved into engagement with the basin and being secured to the conduit;

FIG. 14 is a perspective view from the interior of the basin of FIG. 13;

FIG. 15 is a perspective view similar to FIG. 14 showing placement of flowable sealant;

FIG. 16 is a perspective view of the conduit and basin illustrated in FIG. 15 from an exterior of the basin;

FIG. 17 is a perspective view from the interior of a basin, showing an alternative embodiment of the present disclosure in which the mortar collar is positioned in the interior of the basin; and

FIG. 18 is perspective view similar to the view shown in FIG. 14, but with expanding foam inserted as the flowable sealant.

Corresponding reference characters indicate corresponding parts throughout the several views. The exemplification set out herein illustrates an exemplary embodiment of the invention and such exemplification is not to be construed as limiting the scope of the invention in any manner.

### DESCRIPTION OF EMBODIMENTS OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

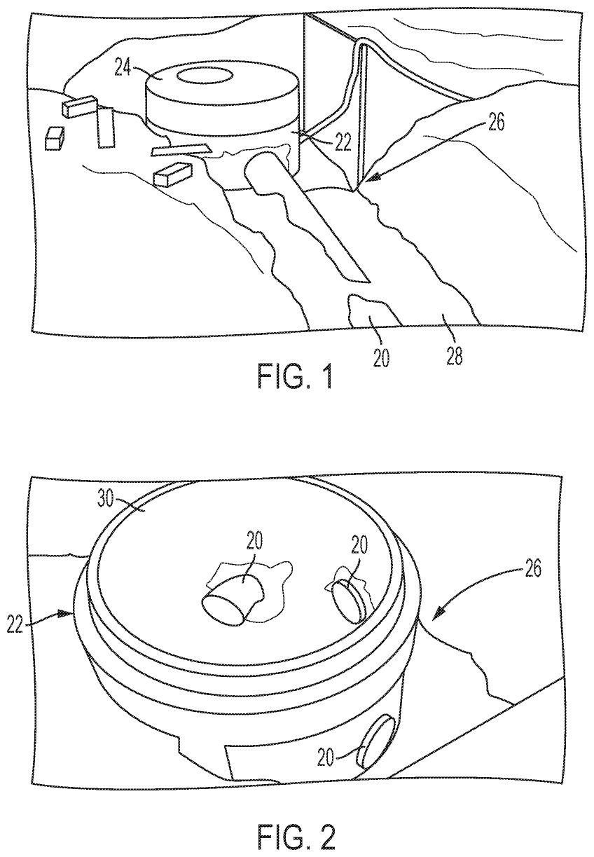

FIG. 1 illustrates components of a sewer system including conduit 20, manhole 22, and manhole cover 24. Conduit 20 and manhole 22 are operably positioned in excavation 26, with the interior passageway of conduit 20 in fluid communication with the interior of manhole 22. Manhole cover 22 is positioned atop manhole 22. Excavation 26 is partially filled with backfill 28. FIG. 2 illustrates the interior of an alternative manhole 22, with a number of conduits 20 extending through wall 30 of manhole 22. Manhole 22 is one type of basin utilized in sewer systems. In the embodiment shown in FIG. 2, two of the illustrated conduits comprise inlets into manhole 22, while the third conduit comprises an outlet from manhole 22.

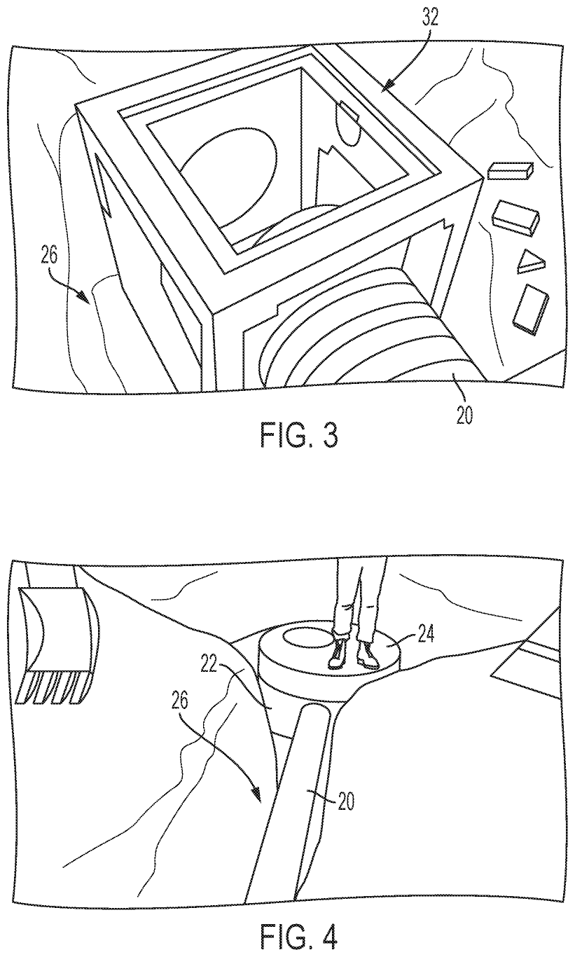

FIG. 3 illustrates another basin useable in a sewer system in the form of catch basin 32. Catch basin 32 can function to retain matter that would not be able to pass easily through the remainder of the sewer system. As with manhole 22 above, catch basin 32 has conduit 20 extending through a wall of the basin to place the interior passageway of conduit 20 in fluid communication with the interior of catch basin 32.

FIG. 4 is a perspective view similar to the view of FIG. 1, but before placement of backfill 28 (FIG. 1) in excavation 26. With conduits 20, manhole 22 and catch basin 32 configured to form a sewer system, sewage or surface runoff can be properly communicated to, e.g., a proper treatment facility. To prevent the fluid conveyed by such a sewer system from exfiltrating to the surrounding soil and to prevent surrounding soil and debris from infiltrating the sewer system, connection of conduits to basins 22, 32 must be properly sealed.

When creating the assemblies illustrated in FIGS. 1-4, it can be difficult to precisely predict the area of conduit 20 that will be positioned through the aperture in the wall of the basin. Therefore, implementing a sealant or sealant component on conduit 20 prior to placement of the conduit 20 through an aperture in basin 30, 32 is counter-indicated. The present disclosure provides a mortar collar for facilitating sealing conduit 20 relative to a basin 30, 32. Much of the detailed disclosure that follows described sealing of conduit 20 relative to manhole 22; however, it sill be understand that manhole 22 is a stand-in for any basin in such description.

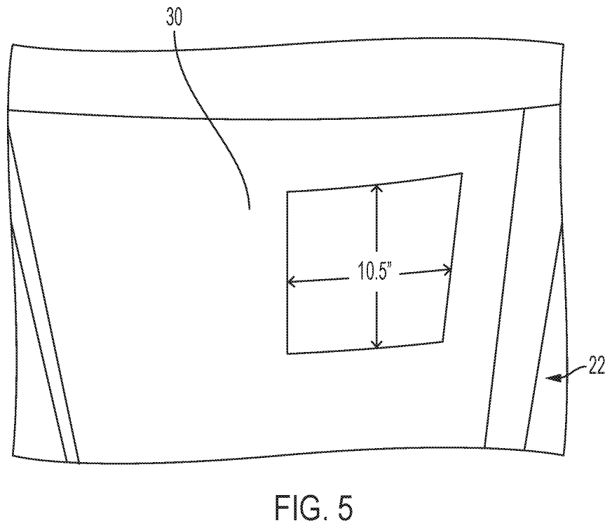

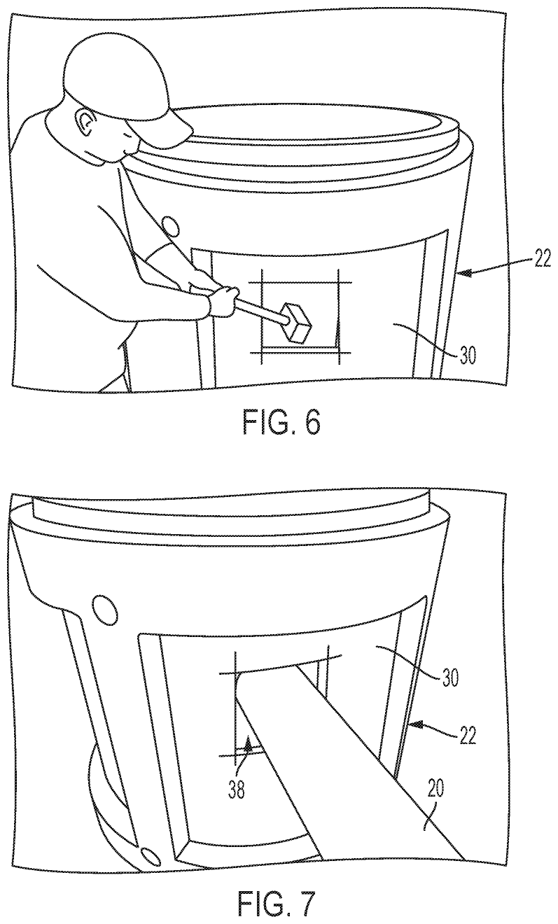

In a new installation, an aperture is cut in the basin to allow connection of a conduit. FIG. 5 shows an exemplary basin in the form of manhole 22. In this exemplification, manhole 22 is being prepared to receive a conduit 20 having a nominal outer diameter of 8 inches. To allow passage of this conduit, while also accounting for the imprecision in placing manhole 22 and conduit 20, an aperture through wall 30 is prepared in the form of a 10.5 inch by 10.5 inch square. The location of the aperture is marked as shown in FIG. 5 are thereafter cut and removed as shown in FIG. 6.

With aperture 33 formed in wall 30 of manhole 22, conduit 20 can be positioned therethrough as shown in FIG. 7. At aperture 33, the thickness of wall 30 supports a flowable sealant positioned between conduit 20 and manhole 22. When constructing a sewer system or effecting a repair to an existing system, timeliness is generally at a premium. Therefore, construction teams many times begin adding backfill to the excavation before the sealant has cured, which can push the sealant out of operative position.

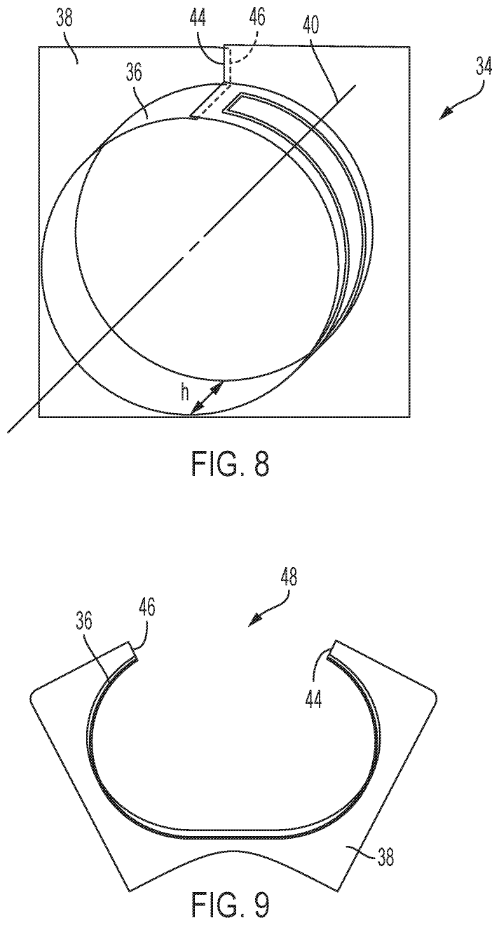

Mortar collar 34 of the present disclosure protects the sealant during the curing process by shielding the sealant during curing. Mortar collar 34 is illustrated in detail in FIGS. 8-10. Mortar collar 34 features riser 36 (which forms a component of a conduit clamp as will be described below) and flange 38. Riser 36 includes a wall positionable into one or more cylindrical configurations, one of which is illustrated in FIG. 8. The wall of riser 36 has a height h from a first end thereof to the opposite end thereof. Height h is sufficiently long to accommodate operative placement of at least one band clamp thereover, as further detailed herein. Flange 38 extends outwardly from riser 36 at the first end of riser 36. In the embodiment illustrated in FIGS. 8-10, flange 38 extends radially relative to longitudinal axis 40 of riser 36. Note that longitudinal axis 40 is the center axis of the nominal cylinder formed by riser 36 in the configuration of mortar collar 34 illustrated in FIG. 8. In this document, “substantially” defining a cylinder is meant to denote nominally defining a cylinder.

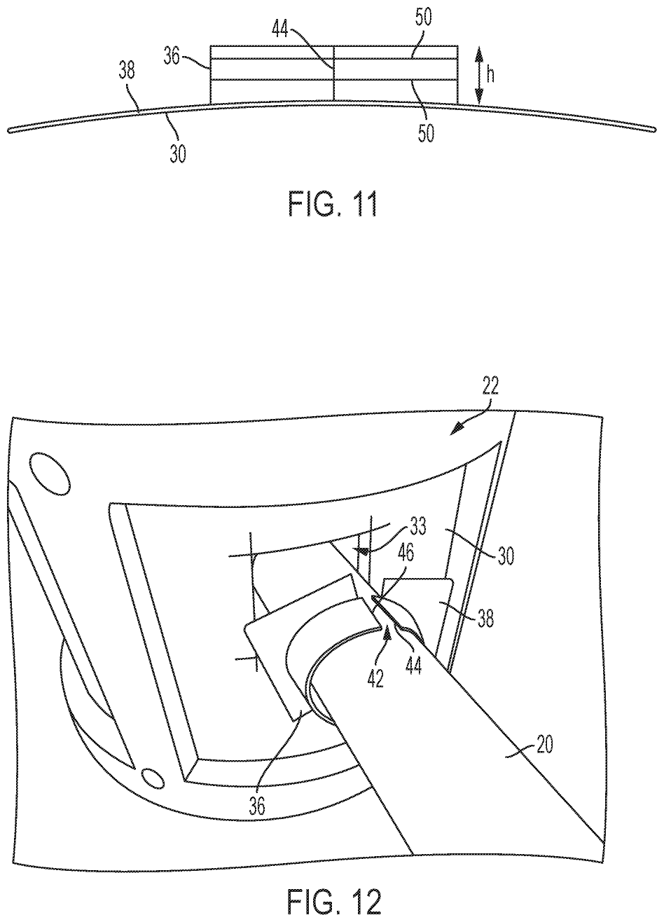

Mortar collar 34 features continuous longitudinal slit 42 (FIG. 12) through the wall of riser 36 and flange 38. Slit 42 is a “longitudinal” slit in that it spans the height h of riser 36, which coincides with the length of mortar collar 34. In the embodiment illustrated in FIG. 8, longitudinal slit 42 runs nominally parallel to longitudinal axis 40 through riser 36 and then radially outwardly from longitudinal axis 40 through flange 38. In certain forms of the present disclosure, the trajectory of slit 42 through flange 38 will be nominally orthogonal to longitudinal axis 40 in the configuration of mortar collar 34 shown in FIG. 8, i.e., a “clamp configuration” as will be further described below.

Slit 42 allows mortar collar 34 to be operably positioned about conduit 20 and relative to a basin such as manhole 22 without requiring exacting arrangement of conduit 20 and manhole 22, as mortar collar 34 can be positioned along the length of conduit 20 at whatever location is desired, as will become further apparent based on the description below. Mortar collar 34 does not present an impediment to assembly of conduit 20 with manhole 22, as mortar collar 34 can be operably positioned after insertion of conduit 20 through aperture 33 (FIG. 7). To operably position mortar collar 34, mortar collar 34 is opened along slit 42 (FIG. 12), as shown in FIG. 9. More particularly, slit 42 defines opposite radial (relative to longitudinal axis 40) ends 44, 46 (FIG. 9) of mortar collar 34 that can be pulled apart to create opening 48 larger in size than the diameter of conduit 20 to which it will be secured. To facilitate opening mortar collar 34 as shown in FIG. 9, the material of mortar collar 34 may be weakened 180 degrees opposite (measured about riser 36) to slit 42 to form a living hinge about which mortar collar 34 can be opened.

With opening 48 sized larger than the diameter of conduit 20, mortar collar 34 can be radially (relative to longitudinal axis 40 shown in FIG. 8 and relative to the longitudinal axis of conduit 20) positioned about conduit 20. Stated another way, mortar collar 34 is positionable over the perimeter of conduit 20 in a direction orthogonal to a longitudinal axis of conduit 20. In the exemplification illustrated, the perimeter of conduit 20 is a circumference of a round conduit. Once conduit 20 occupies riser 36, as illustrated in FIG. 12, ends 44, 46 of mortar collar 34 can be brought together to tightly position the interior surface of riser 36 against the outer surface or perimeter of conduit 20. More particularly, mortar collar 34 is positioned in a clamp configuration with riser 36 (which comprises a component of a conduit clamp of mortar collar 34, as will be further described below) having a shape corresponding to a perimeter shape of a perimeter of conduit 20, and with flange 38 covering aperture 33 (FIG. 7) and otherwise abutting manhole 22. A shape “corresponding to” the shape of conduit means that in the clamp configuration, riser 36 is substantially congruent to conduit 20, but slightly oversized thereto (as is required to have riser 36 positioned atop conduit 20). A shape “corresponding to” means that the inner dimension of riser 36 is nominally the same as the outer dimension of conduit 22.

With riser 36 and flange 38 positioned in the clamp configuration, as described above, mortar collar 34 is secured in position as shown in FIG. 13. Particularly, at least one zip tie 50 is positioned and tightened over riser 36, with zip tie 50 and riser 36 clamped against conduit 20. In this document, riser 36 and a band clamp (e.g., zip tie 50 or a hose clamp) comprise components of a conduit clamp. Grooves such as the ones illustrated on riser 36 in FIG. 8 could be used to facilitate positioning of zip ties 50 on riser 36.

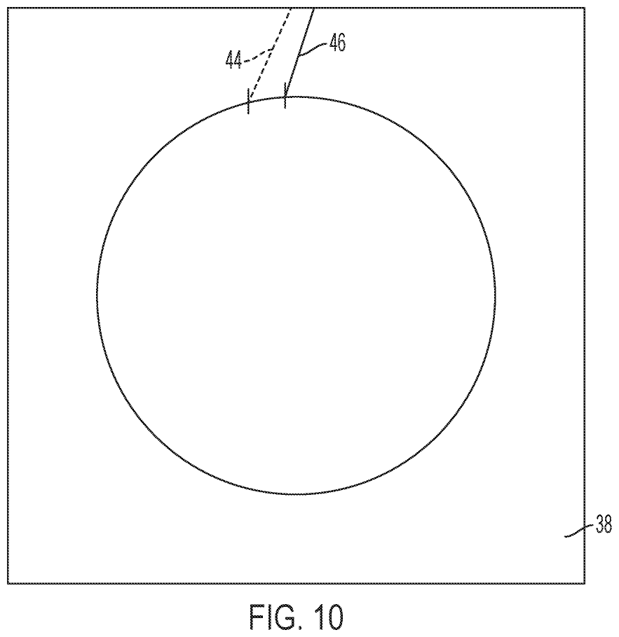

When operatively positioning mortar collar 34 as described above, ends 44, 46 can overlap as illustrated, e.g., in FIGS. 8 and 10. Ends 44, 46 extend through both riser 36 and flange 38. This overlap can account for manufacturing tolerances in conduits 20. Specifically, overlapping ends 44, 46 of riser 36 allow riser 36 to be tightened on varying pipe sizes, while overlapping ends 44, 46 of flange 38 allow flange 38 to adjust and cover the basin wall opening while clamp 36 is adjusting to the conduit size. Flange 38 can, in certain alternative embodiments, be circular or round such that overlapping ends 44, 46 can be positioned relative to one another to greatly vary the internal diameter of riser 36. In such a configuration, a single mortar collar could accommodate a wide variety of pipe sizes.

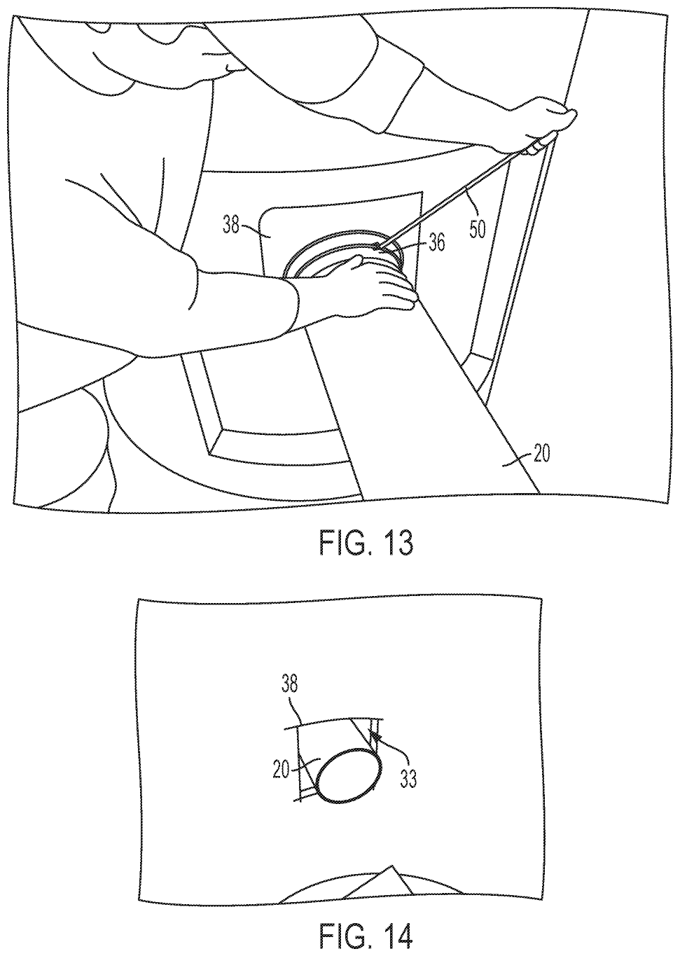

Flange 38 is configured to have a geometry corresponding to the geometry of the wall of the basin against which it will bear in the operative position. For example, flange 38 can be curved to match the curvature of a curved wall of manhole 22, as shown in FIG. 11. More particularly, wall 30 of manhole 22 can be curved in a plane perpendicular to a longitudinal axis of manhole 22. With mortar collar 34 operatively positioned as illustrated, e.g., in FIG. 13, it can act as a backstop for flowable sealant 52. FIG. 14 illustrates aperture 33 covered by flange 38 of mortar collar 34. With mortar collar positioned exterior of manhole 22, as illustrated in FIG. 14, flowable sealant, such as mortar, grout, or concrete can be operably positioned to seal conduit 20 relative to manhole 22. In this document “mortar collar” is used as a shorthand for “flowable sealant collar,” i.e., a mortar collar of the present disclosure is useable with any flowable sealant, not merely mortar. The term “mortar” in the description “mortar collar” is not limiting in any way to the structure of the mortar collar.

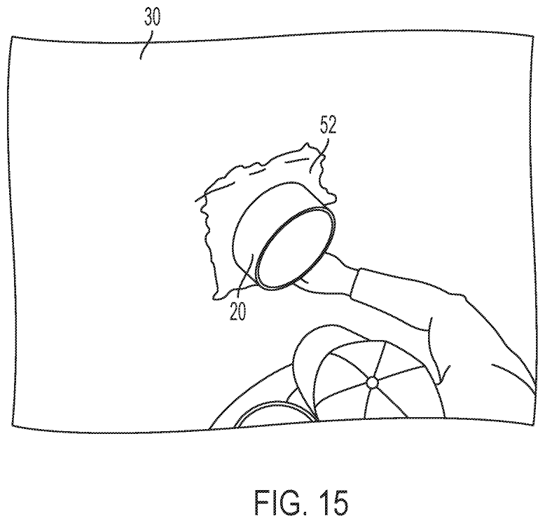

Referring to FIG. 15, flowable sealant 52 is packed into aperture 33 (FIG. 14) and between conduit 20 and manhole 22 to create a seal therebetween. Without mortar collar 34, flowable sealant 52 could run out of aperture 33 on the side of wall opposite to the position of the worker placing the sealant 52. For example, in the arrangement illustrated in FIGS. 13-15, placement of sealant 52 from an interior of manhole 22 could be stymied by flow of the sealant out of aperture 33 to an exterior of manhole 22. Without mortar collar operably positioned as a backstop, a second installer would be needed to prevent such outflow of sealant.

Mortar collar 34 can be designed as a single use item. In such a configuration, it can be left in place after use, allowing the backfill process to begin prior to curing of sealant 52. Without mortar collar 34, backfilling prior to curing of sealant 52 could cause a blowout of sealant 52 by the pressure of the backfill.

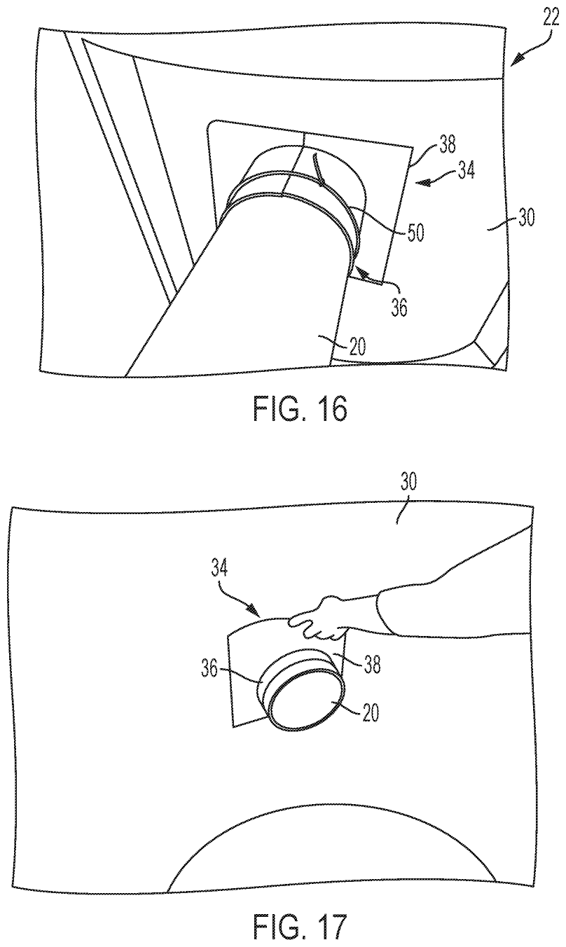

The process of utilizing mortar collar 34 described above with respect to FIGS. 13-16 can be reversed, with mortar collar 34 being positioned interior of manhole 22, as illustrated in FIG. 17. In this position of mortar collar 34, sealant 52 will be positioned from exterior of manhole 22. Backfill will not blowout sealant 52, as mortar collar 34 will act as a backstop. This embodiment is particularly useful in limited access basins. In further alternatives, a second mortar collar 34 could be positioned after placement of sealant 52, such that sealant 52 is trapped between the two mortar collars.

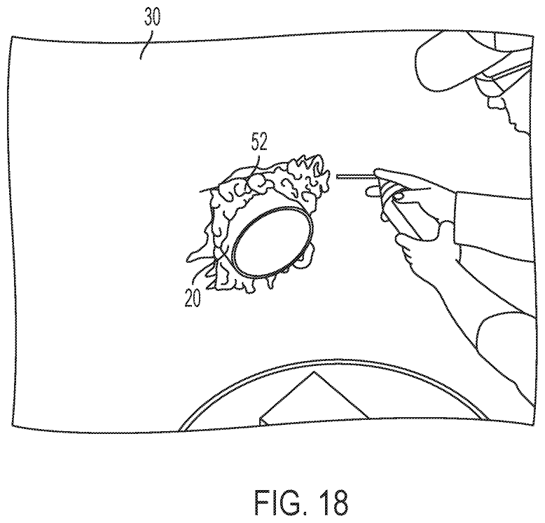

FIG. 18 illustrates use of an expanding foam as flowable sealant 52.

Mortar collar 34 can be made in a number of different sizes corresponding to the components of the desired sewer system. Mortar collar 34 will, in certain embodiments thereof, be constructed of plastic. In embodiments made of plastic, the material will be sized to provide a living hinge 180 degrees opposite ends 44, 46 (measured about riser 36) to allow positioning of mortar collar about conduit 22, as described above. Alternative materials of construction for mortar collar 34 include rubber, lightweight steel, and aluminum. Depending on the rigidity of these alternative materials of construction, the aforementioned living hinge may be replaced with an actual hinge. Flange 38 will be sufficiently rigid to prevent flowable sealant 52 from escaping from between flange 38 and manhole 22 during installation of flowable sealant 52. In the event that flange 38 is nominally planar, mortar collar 34 could be sized to accommodate the largest expected construct and simply trimmed to size, as needed.

1. A mortar collar for protecting a flowable sealant positioned between a wall having an aperture through which a conduit is positioned, the mortar collar comprising:
a conduit clamp having a wall having a height spanning a first end and a second end of the wall, the wall of the conduit clamp positionable in a clamp configuration, in the clamp configuration an interior surface of the wall of the conduit clamp having a shape corresponding to a perimeter shape of a perimeter of the conduit, such that the wall is sealable against the conduit,
in the clamp configuration, and with the conduit clamp is positioned about the perimeter of the conduit, the interior surface of the wall of the conduit clamp abutting the perimeter of the conduit; and
a flange extending outwardly from an exterior surface of the wall of the conduit clamp at the first end of the wall, the flange sized to cover the aperture in the wall through which the conduit is positioned when the conduit clamp is positioned about the perimeter of the conduit.

2. The mortar collar of claim 1, wherein the mortar collar defines a continuous longitudinal slit through the wall of the conduit clamp and the flange, the mortar collar openable along the slit to be positionable over the perimeter of the conduit in a direction orthogonal to a longitudinal axis of the conduit.

3. The mortar collar of claim 1, wherein the perimeter comprises a circumference.

4. The mortar collar of claim 1, wherein the wall is a basin wall and the conduit is in fluid communication with an interior of the basin, the wall defining a wall radius of curvature in a plane perpendicular to a longitudinal axis of the basin, wherein the flange defines a flange radius of curvature mating with the wall radius of curvature, whereby, with the flange positioned atop the wall, the flange abuts the wall.

5. The mortar collar of claim 1, wherein, in the clamp configuration an interior surface of the wall of the conduit clamp substantially defines a cylinder.

6. The mortar collar of claim 1, wherein the conduit clamp further comprises a band clamp positionable over the wall of the conduit clamp and tightenable thereabout to secure the conduit clamp to the conduit.

7. A method of sealing a conduit within an aperture in a wall, comprising:
positioning the conduit through the aperture in the wall;
affixing a mortar collar about a periphery of the conduit and covering the aperture in the wall, the affixing step performed subsequent to the step of positioning the conduit through the aperture in the wall, the affixing step positioning the mortar collar to cover the aperture; and
positioning a flowable sealant between the wall and the conduit in the aperture in the wall, the mortar collar covering the sealant on a first side of the wall.

8. The method of claim 7, further comprising:
cutting the wall to create the aperture prior to the step of positioning the conduit through the aperture in the wall.

9. The method of claim 7, wherein the mortar collar comprises:
a conduit clamp having a wall having a height spanning a first end and a second end of the wall, the wall of the conduit clamp positioned in the affixing step in sealing relationship with the conduit.

10. The method of claim 9, wherein the mortar collar defines a continuous longitudinal slit through the wall of the conduit clamp, the affixing step comprising:
opening the mortar collar along the slit; and
positioning the conduit through the opened slit of the mortar collar.

11. The method of claim 10, wherein the step of positioning the conduit through the opened slit of the mortar collar comprises:
moving the mortar collar orthogonal to a longitudinal axis of the conduit.

12. The method of claim 9, wherein the mortar collar comprises:
a flange extending outwardly from an exterior surface of the wall of the conduit clamp at a first end of the wall, the flange covering the aperture in the wall and abutting the wall about the aperture as a result of the affixing step.

13. The method of claim 9, wherein the mortar collar comprises:
a conduit clamp having a wall having a height spanning a first end and a second end of the wall, the wall of the conduit clamp positioned in the affixing step in sealing relationship with the conduit; and
a flange extending outwardly from an exterior surface of the wall of the conduit clamp at a first end of the wall, the flange covering the aperture in the wall and abutting the wall about the aperture as a result of the affixing step.

14. The method of claim 13, wherein the mortar collar defines a continuous longitudinal slit through the wall of the conduit clamp and the flange, the affixing step comprising:
opening the mortar collar along the slit; and
positioning the conduit through the opened slit of the mortar collar.

15. The method of claim 14, wherein the step of positioning the conduit through the opened slit of the mortar collar comprises:
moving the mortar collar orthogonal to a longitudinal axis of the conduit.

16. The method of claim 7, wherein the wall forms a part of a basin having an interior, and wherein the step of positioning the conduit through the aperture in the wall comprises positioning an end of the conduit in fluid communication with the interior of the basin.

17. The method of claim 16, wherein the step of affixing a mortar collar about a periphery of the conduit and covering the aperture in the wall comprises positioning the mortar collar within the interior of the basin.

18. The method of claim 16, wherein the step of affixing a mortar collar about a periphery of the conduit and covering the aperture in the wall comprises positioning the mortar collar exterior of the basin.

19. The method of claim 17, further comprising:
affixing a second mortar collar about the periphery of the conduit and covering the aperture in the wall, the step of affixing a second mortar collar performed subsequent to the step of positioning the conduit through the aperture in the wall, the step of affixing a second mortar collar positioning the second mortar collar to cover the aperture.

20. The method of claim 7, further comprising:
after the positioning a flowable sealant step, backfilling a backfill adjacent to the wall, with the mortar collar retaining the flowable sealant and preventing the backfill from a blowout of the flowable sealant.
